(19) United States
(12) Patent Application Publication
(10) Pub. No.: US 2012/0174076 A1
(43) Pub. Date: Jul. 5, 2012

(54) SYSTEMS AND METHODS FOR PROFILING SERVERS

(76) Inventor: Zoran Rajic, San Jose, CA (US)

(21) Appl. No.: 12/984,197

(22) Filed: Jan. 4, 2011

(51) Int. Cl. G06F 9/44

(52) U.S. Cl. 717/128

(57) ABSTRACT

Systems and methods for implementing a server profiling device are provided. For example, one method of profiling servers includes implementing a replacement call to intercept a system call using a library wrapper function, and determining a thread identifier for the system call. The method also includes collecting data for an operation of the thread identifier, and creating an in-memory table to store the collected data for the thread identifier. The method also includes obtaining a stack-trace for a number of running threads and combining the stack-trace with the data collected for the thread identifier, and presenting the stack-trace combined with the data collected through a user interface.

### BACKGROUND

Gaining insight into program behavior is valuable in troubleshooting problems that occur when running operations, processes, and applications. In Java application servers problems can present themselves in the form of slow processing, resource hogging, and/or error messages, among others. Tools exist to extract data and alert technologists that something may be wrong with the way a program is running. Using the existing tools to visualize and properly diagnose a problem presents a challenge. Examples of available tools include manual code inserts, tracers, and memory profilers. Manual code inserts require significant resources in terms of labor intensive and time consuming human analysis to manually go through thousands of lines of code, print and repeat. Tracers can trace the execution of the program by dumping volumes of system calls, but have no insight about the system-calls that the Java Virtual Machine is making. Native memory profilers, which focus on memory leak detection, can keep track of operations. For example, Java memory profilers can operate by keeping track of Java allocated objects and subroutines in memory.

Unfortunately, storing, processing, and displaying this data can be a significant resource drain and result in a huge system performance penalty. The memory used may be many times greater than that used by the Java Virtual Machine alone, e.g. gigabytes. The memory consumed in running a Java Virtual Memory Tool Interface (JVMTI) can make running this profiler for longer than several minutes nearly prohibitive. With the size of programs needed to be run in solving complex problems, existing tools can fall short of the needs of technologists in profiling servers.

### BRIEF DESCRIPTION OF THE DRAWINGS

FIG. 1 is a flow chart illustrating an example of a method for profiling a server.

FIG. 2A is a block diagram illustrating an example of a method for profiling a server.

FIG. 2B is a block diagram illustrating an example of reading a value preceding a memory pointer pointing to a memory block according to an embodiment of the present disclosure.

FIG. 3A, illustrates an example of an in-memory table for use in profiling a server.

FIG. 3B, illustrates an example of information that can be provided via a user interface for profiling a server.

FIG. 4 illustrates an example of a system for profiling a server.

FIG. 5 illustrates a block diagram of an example of a computer-readable medium (CRM) in communication with processing resources for profiling a server.

### DETAILED DESCRIPTION

Systems and methods for profiling servers are provided. For example, one method of profiling servers includes implementing a replacement call to intercept a system call using a library wrapper function and determining a thread identifier for the system call. The method also includes collecting data for an operation of the thread identifier and creating an in-memory table to store the collected data for the thread identifier. The method also includes obtaining a stack-trace for a number of running threads, combining the stack-trace with the data collected for the thread identifier, and presenting the stack-trace combined with the data collected through a user interface.

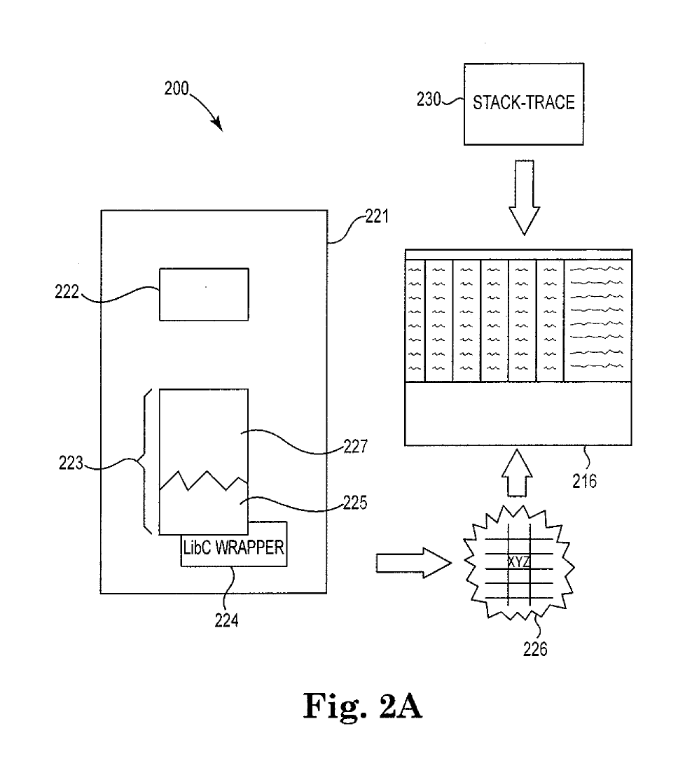

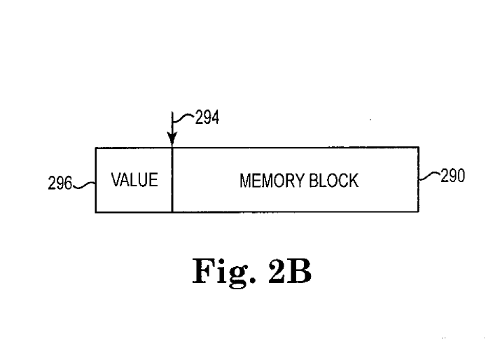

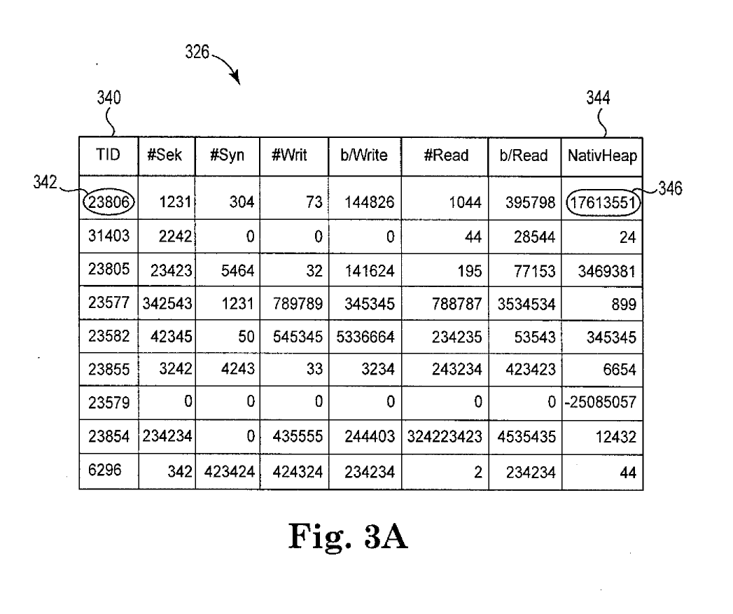

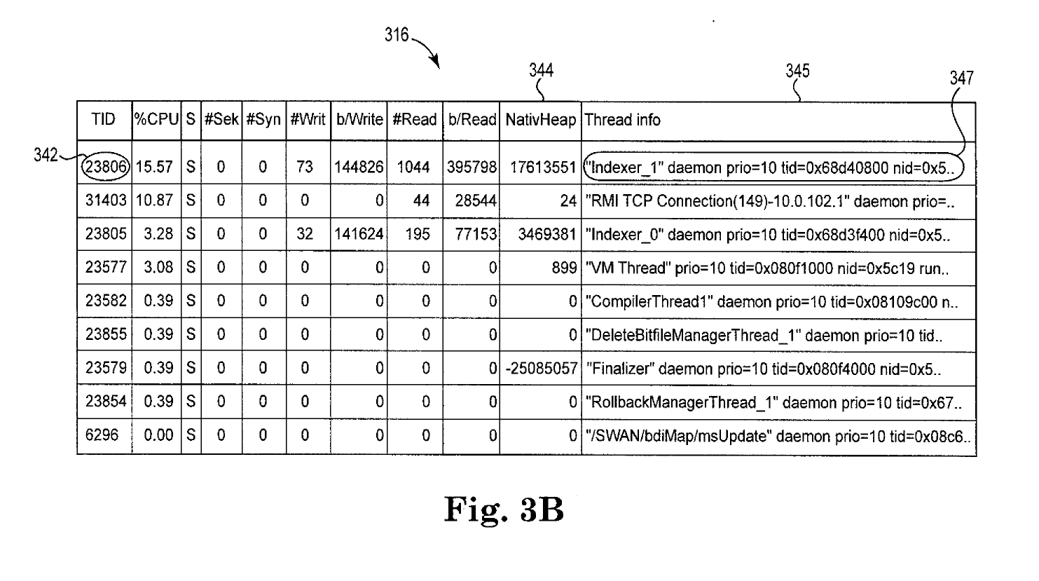

The figures herein follow a numbering convention in which the first digit corresponds to the drawing figure number and the remaining digits identify an element in the drawing. Similar elements between different figures may be identified by the use of similar digits. For example, number 216 may reference element “16” in FIG. 2A, and a similar element may be referenced as 316 in FIG. 3B.

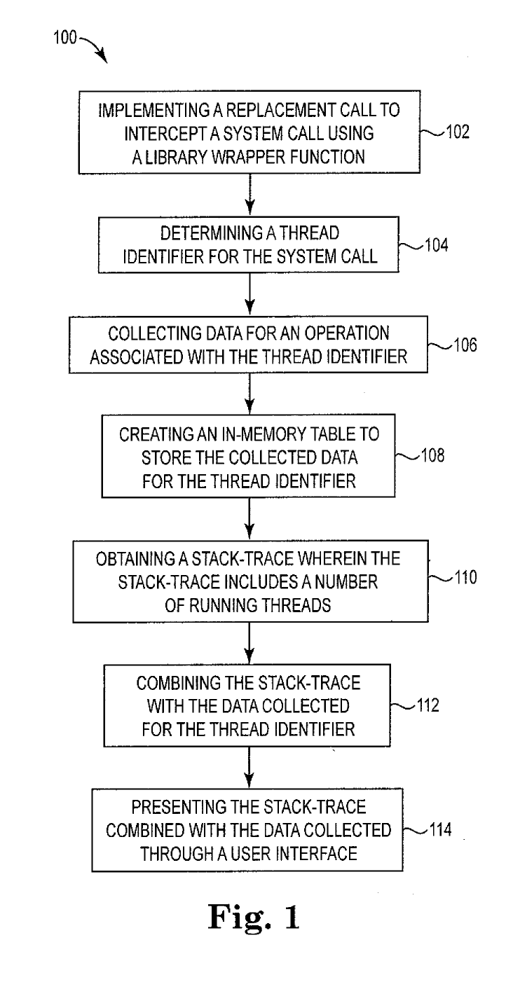

FIG. 1 is a flow chart illustrating an example of a method 100 for profiling a server. As will be explained in more detail below, a method 100 of profiling servers includes executing instructions to implement a replacement call to intercept a system call using a library wrapper function as shown at block 102. As shown the method includes executing instructions to determine a thread identifier for the system call at block 104 and executing instructions to collect data for an operation associated with the thread identifier as shown at block 106. At block 108, the method includes executing instructions to create an in-memory table to store the collected data for the thread identifier. At block 110, the method includes executing instructions to obtain a stack-trace wherein the stack-trace includes a number of running threads. At block 112, the method includes executing instructions to combine the stack-trace with the data collected for the thread identifier. At block 114, the method includes executing instructions to present the stack-trace combined with the data collected through a user interface.

FIG. 2A is a block diagram illustrating an example of a method 200 for profiling a server 221. The diagram illustrates an application server 221 with memory 223, e.g., Java Virtual Memory, coupled to a Java application processor 222. The memory 223 can include running programs 225 with a portion 227 of the Java Virtual Memory available to the processor 222. An example of a method 200 of profiling a server replaces a system call with a replacement call using a library wrapper function 224, e.g., “LibC WRAPPER.” As shown in FIG. 2A, an example of a library wrapper function 224 includes using a LibC wrapper to implement the replacement call intercept. The replacement call can cause instructions to be executed to capture data that would be associated with executing a system call made by an application process, e.g., executing instructions. When profiling a server, the running program 225 executes the replacement call, which performs an operation, determines which thread invoked the requested system call, e.g., as denoted by a thread identifier, and updates an in-memory table 226. Having determined which thread invoked a system call and having denoted the thread with a thread identifier, the information collected by the replacement call can be stored in the in-memory table with the associated thread identifier. Thread identifiers are one example of the data that can be stored in the in-memory table 226. In an example, the thread identifier can indicate in which row of the in-memory table 226 to store updated information associated with the thread identifier. Other examples of information and data associated with a thread that can be stored in the in-memory table 226 can include a number of seek operations, a number of write operations, and a number of bytes written, among others. The in-memory table 226 is presented via the user interface 216 in combination with the results of a stack-trace 230, as described in more detail below.

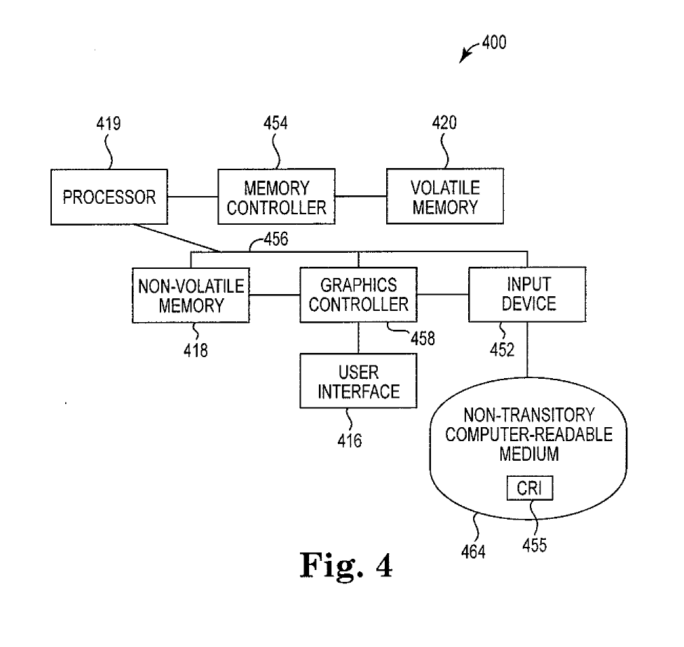

FIG. 2B is a block diagram illustrating an example of reading a value 296 preceding a memory pointer 294 pointing to a memory block 290. As shown in FIG. 2B, rather than track each memory block in the execution of a thread, instructions are executed to look to a value 296 preceding a memory pointer 294 to determine the size of a memory block 290. This allows for tracking memory allocation while using fewer processing resources than other tracking methods, such as manual code inserts, tracers, or memory profilers. In system memory, e.g., volatile memory 420 in FIG. 4, a value 296 exists to identify a size of a memory block 290, as implemented and managed by the operating system. By executing instructions to locate the value 296 in the system memory layout, the size of the memory block 290 can be determined. In the system memory, memory blocks are identified by a memory pointer 294 pointing to the memory block 290, e.g., holding the address of the memory block 290. In an example of the present disclosure, the value 296 preceding the memory pointer 294 indicates the size of the memory block 290 being allocated. By executing instructions to read the value 296 preceding the memory pointer 294, the size of the memory block 290 can be obtained, and instructions can be executed to update the in-memory table 226 with the collected information. For example, a replacement call can be implemented to either allocate or free the memory block 290. In the in-memory table 226, the size of the memory block 290 can be associated with the thread identifier running the system call, “malloc( )”, e.g., memory allocation. The system call is then returned to the Java Virtual Memory, for example. Some examples of the present disclosure include reading the value 296 preceding the pointer 294 to determine the size of the memory block 290 in Linux, HP-UX, Sun Solaris, and/or IBM AIX systems, among others.

As shown in FIG. 2A, and described in greater detail in 3B, a stack-trace 230 can be obtained to provide information about a number of running threads. The stack-trace 230 can include the thread identifier, e.g., represented numerically and/or what the thread is doing, e.g., represented by text and/or the user-defined name for the thread identifier, among other information. The stack-trace 230 can be provided by running a jstack tool, for example. The jstack tool can be a component of a development kit, such as a Java Development Kit. The stack-trace 230 can include subroutines, which have not yet terminated in the program. Having combined the in-memory table 226 results for the thread identifier with the stack-trace 230 results for the thread identifier, the data collected on the thread identifiers can be presented to the user interface 216. A user can use the results of the collected system call statistics to analyze the running programs. Instructions can be executed to collect more information about the thread, such as CPU usage, current state of thread, e.g., active or sleeping, among others. This information can also be presented through the user interface 216.

In some examples of the present disclosure, the system calls can be intercepted from the LibC library. Some examples of LibC function calls include, “read ( ), “write ( )”, “malloc( )”, “free( )”, etc. Using the LibC functions “malloc ( )”/“free ( )” avoids the need to create a reference table of individually allocated memory blocks to determine the amount of memory allocated for running a Java application. Extensive reference tables can be reduced and processing resources can be freed up for large analyses. By tracking the size of memory blocks freed by the thread identifier(s), the resource impact on the Java Virtual Memory and overall operating system during profiling can be kept at a low level. Library wrapper functions can include those beyond LibC.

FIG. 3A, illustrates an example of an in-memory table 326 for use in profiling a server. In an example, the in-memory table 326 contains a number of thread identifiers in the thread identifier column, abbreviated “TID” 340. In the first row the thread identifier labeled 342 is an example of a thread identifier. Data collected by executing the replacement call is stored in the row associated with the thread identifier. Examples of data collected from a number of operations include a number of seek operations (“#Sek”), a number of write operations (“#Writ”), a number of bytes written (“b/Write”), a number of read operations (“#Read”), and number of bytes read (“b/Read”), among other data. In an example, the values collected in the in-memory table 326 represent the resource usage since the processing thread started. The values presented via the user interface (see FIG. 2A, also described in greater detail in FIG. 3B), represent how the values change over time.

In an example of the present disclosure, the replacement call can cause instructions to be executed to intercept a “write( )” system call, invoke the actual “write( )” call, and update the in-memory table 326 with the results. The replacement call can cause instructions to be executed to determine which thread identifier invoked the “write( )” system call. The in-memory table 326 can be updated each time the replacement call causes instructions to be executed to perform the intended system call operation. In addition, the replacement call can collect information to determine which thread invoked the replacement call and update the in-memory table 326 with the information collected, e.g. values stored in the in-memory table 326 associated with the thread identifier 342. Considering an example where a replacement call causes instructions to be executed to intercept a first “write( )” system call, followed by a second “write( )” system call, instructions would be executed to update to the in-memory table 326 following interception of the second “write( )” call, such that the number of write operations stored in the in-memory table 326 would increment 1 over the previous number of write operations stored, e.g., from 1 to 2. Likewise, the number of bytes written can be incremented over a previous number of bytes written based on the data collected by executing instructions to run of the actual “write( )” call, e.g., from 68123 to 144826.

A native memory allocation 346, for example, stored in the column titled “NativHeap” 344, can be updated when the replacement call causes instructions to be executed to intercept the system call. The replacement call identifies the thread identifier that invoked the system call. The replacement call can cause instructions to be executed to intercept a “malloc( )” call. The replacement call causes instructions to be executed to collect data on the size of the memory block allocated or freed by the thread identifier that invoked the “malloc( )” call. The replacement call updates the in-memory table 326 with the size of the memory block freed. A native memory allocation can also be stored in the in-memory table 326.

FIG. 3B, illustrates an example of information that can be provided via a user interface 316 for profiling a server. For example, the results of the stack-trace can be presented in the column titled, “Thread info” 345. An example, a stack-trace associated with a thread identifier 342 is presented at 347. The user interface 316 can display a number of thread identifiers along with a number of running threads, information collected from a number of system calls, and/or how they change over time, e.g., how much data was read per second or how memory was allocated per second. These differences may help a user discern differences and/or trends in the values presented. The column titled, “NativHeap” 344 is an example of a column presented from the in-memory table described in detail in FIG. 3A. The user interface 316 may also include additional application specific thread information, such as % CPU usage and other information from the in-memory table 326, e.g., a number of seek operations (“#Sek”), a number of write operations (“#Writ”), a number of bytes written (“b/Write”), a number of read operations (“#Read”), and number of bytes read (“b/Read”), as described in connection with FIG. 3A, among other data.

The threads can be sorted by the magnitude of the differences in memory allocation using the column titled “NativHeap” 344. For example, the column “NativHeap” 344 can be sorted in descending order by differences, or changes, to facilitate identification of potential problems with the running programs. The display of information through the user interface 316 allows for real-time troubleshooting of running threads. Rather than relying on tracking Java objects using an instantiated heap, examples of the present disclosure can provide the technologist with detail on running programs. The user interface presents to the user what running threads within the Java Virtual Memory are doing coupled with what the operating system knows about the threads. Detail provided by presenting the stack-trace combined with the data collected for a thread identifier, including for example a size of the memory block, through a user interface can be used to efficiently troubleshoot running programs. Fewer processing resources than previous troubleshooting methods, such as manual inserts, tracers, or memory profilers, can be used.

FIG. 4 illustrates an example of a system for profiling a server. The system 400 for profiling a server can include processor resources 419 and memory resources, e.g., volatile memory 420 and/or non-volatile memory 418, for executing instructions. The volatile memory 420 and the non-volatile memory 418 are computer readable media. The processor resources 419 and the memory resources can execute instructions stored in a non-transitory computer-readable medium 450. The processor resources 419 can control the overall operation of the system 400. The processor resources 419 can be connected to a memory controller 454, which can read and/or write data from and/or to volatile memory 420, e.g., online memory, and/or non-volatile memory 418, e.g., persistent memory. A computer, e.g., a computing device, can include and/or receive a tangible non-transitory computer-readable medium 464 storing a set of computer-readable instructions 455 via an input device 452. The computer readable instructions 455 are executed by a processor 419 for profiling a server, as described herein.

The processor resources 419 can be connected to a bus 456 to provide for communication between the processor resources 419, and other portions of the system 400. The non-volatile memory 418 can provide persistent data storage for the system 400. The graphics controller 458 can connect to a user interface 416, which can provide an image to a user based on activities performed by the system 400.

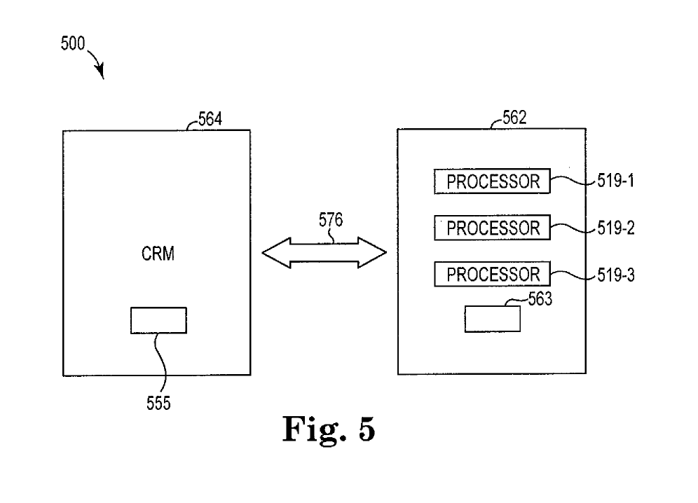

FIG. 5 illustrates a block diagram 500 of an example of a computer-readable medium (CRM) 564 in communication with a computing device 562, e.g., Java application server, having processor resources of more or fewer than 519-1, 519-2, 519-3, that can be in communication with, and/or receive a tangible non-transitory computer readable medium (CRM) 564 storing a set of computer readable instructions 555 executable by one or more of the processor resources, e.g., 519-1, 519-2, 519-3, for profiling a server, as described herein.

Processor resources can execute computer-readable instructions 555 that are stored on an internal or external non-transitory computer-readable medium 564. A non-transitory computer-readable medium (e.g., computer readable medium 564), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), magnetic memory such as a hard disk, tape drives, floppy disk, and/or tape memory, optical discs, digital video discs (DVD), high definition digital versatile discs (HD DVD), compact discs (CD), and/or a solid state drive (SSD), flash memory, etc., as well as other types of machine-readable media.

The non-transitory computer-readable 564 medium can be integral, or communicatively coupled, to a computing device, in either in a wired or wireless manner. For example, the non-transitory computer-readable medium can be an internal memory, a portable memory, a portable disk, or a memory located internal to another computing resource (e.g., enabling the computer-readable instructions to be downloaded over the Internet).

The CRM 564 can be in communication with the processor resources, e.g., 519-1, 519-2, 519-3, via a communication path 576. The communication path 576 can be local or remote to a machine associated with the processor resources 519-1, 519-2, 519-3. Examples of a local communication path 576 can include an electronic bus internal to a machine such as a computer where the CRM 564 is one of volatile, non-volatile, fixed, and/or removable storage medium in communication with the processor resources, e.g., 519-1, 519-2, 519-3, via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

In other examples, the communication path 576 can be such that the CRM 564 is remote from the processor resources, e.g., 519-1, 519-2, 519-3, such as in the example of a network connection between the CRM 564 and the processor resources, e.g., 519-1, 519-2, 519-3. That is, the communication path 576 can be a network connection. Examples of such a network connection can include a local area network (LAN), a wide area network (WAN), a personal area network (PAN), and the Internet, among others. In such examples, the CRM 564 may be associated with a first computing device and the processor resources, e.g., 519-1, 519-2, 519-3, may be associated with a second computing device 562, e.g., a Java application server.

Although specific examples have been illustrated and described herein, those of ordinary skill in the art will appreciate that an arrangement calculated to achieve the same results can be substituted for the specific examples shown. This disclosure is intended to cover adaptations or variations of a number of examples of the present disclosure. It is to be understood that the above description has been made in an illustrative fashion, and not a restrictive one. Combination of the above examples, and other examples not specifically described herein will be apparent to those of skill in the art upon reviewing the above description. The scope of the examples of the present disclosure includes other applications in which the above structures and methods are used. Therefore, the scope of a number of examples of the present disclosure should be determined with reference to the appended claims, along with the full range of equivalents to which such claims are entitled.

Throughout the specification and claims, the meanings identified below do not necessarily limit the terms, but merely provide illustrative examples for the terms. The meaning of “a,” “an,” and “the” includes plural reference, and the meaning of “in” includes “in” and “on.” The phrase “in an example,” as used herein does not necessarily refer to the same example, although it may.

What is claimed:

1. A method of profiling servers, comprising:
implementing a replacement call to intercept a system call using a library wrapper function;
determining a thread identifier for the system call;
collecting data for an operation associated with the thread identifier;
creating an in-memory table to store the collected data for the thread identifier;
obtaining a stack-trace wherein the stack-trace includes a number of running threads;
combining the stack-trace with the data collected for the thread identifier; and
presenting the stack-trace combined with the data collected through a user interface.

2. The method of claim 1, wherein the system call includes a malloc( ) call.

3. The method of claim 2, further comprising identifying a size of a memory block for the thread identifier by reading a value preceding a memory pointer in a system memory layout; and
freeing the memory block after identifying the size of the memory block.

4. The method of claim 1, wherein the library wrapper function is a LibC library wrapper function.

5. The method of claim 1, wherein the user interface displays a native memory allocation for the thread identifier.

6. A server profiler system, comprising:
a processor and a memory coupled to the processor, wherein the memory includes stored executable instructions executed by the processor to:
implement a replacement call to intercept a system call using a library wrapper function;
determine a thread identifier for the system call;
identify a size of a memory block for the thread identifier by reading a value preceding a memory pointer in the system memory layout;
store the size of the memory block for the thread identifier in an in-memory table;
obtain a stack-trace of running threads wherein the stack-trace includes the thread identifier;
combine the stack-trace with the size of the memory block for the thread identifier; and
present the stack-trace combined with the size of the memory block for the thread identifier through a user interface.

7. The server profiler system of claim 6, further comprising free the memory block after identifying the size of the memory block;

8. The server profiler system of claim 7, further comprising update a native memory allocation for the thread identifier wherein updating the native memory allocation includes summing the size of the memory blocks freed for the thread identifier.

9. The server profiler system of claim 8, further comprising present the updated native memory allocation through the user interface

10. The server profiler system of claim 6, wherein the in-memory table contains the number of seek operations.

11. A non-transitory computer-readable medium for server profiling with instructions stored thereon executed by a process to:
create an in-memory table;
implement a replacement call to intercept a system call using a library wrapper function;
determine a thread identifier for the system call;
identify a size of a memory block for the Java thread identifier by identifying a value preceding a memory pointer;
free the memory block after identifying the size of a memory block;
store the size of the memory block that was freed with the Java thread identifier in the in-memory table;
obtain a stack-trace of a number of running threads wherein the number of running threads includes the Java thread identifier;
combine the stack-trace with the in-memory table; and
display the combination of the stack-trace with the in-memory table through a user interface.

12. The server profiler of claim 11, wherein the in-memory table contains the number of sync operations.

13. The server profiler of claim 11, wherein the combination of the stack-trace with the in-memory table displayed through the user interface includes a native memory allocation for a number of Java thread identifiers.

14. The server profiler of claim 11, wherein the user interface updates when the in-memory table is updated with information associated with the thread identifier.

15. The server profiler of claim 11, wherein the library wrapper is a LibC wrapper library.
